(19) United States
(12) Patent Application Publication
(10) Pub. No.: US 2025/0039631 A1
(43) Pub. Date: Jan. 30, 2025

(54) APPARATUS, SYSTEM, AND METHOD FOR STABILIZING APPARENT AZIMUTHAL ANGLES OF AUDIO SIGNALS IN ENVIRONMENTS OF VARYING ACOUSTIC FIDELITY

(71) Applicant: Meta Platforms Technologies, LLC, Menlo Park, CA (US)

(72) Inventors: William Brimijoin Brimijoin, II, Kirkland, WA (US); Andrew Lovitt, Redmond, WA (US); Antje Ihlefeld, Redmond, WA (US); Carl Schissler, Carrboro, NC (US); Andrew Jackson Stockton X, Boston, MA (US)

(21) Appl. No.: 18/672,832

(22) Filed: May 23, 2024

Related U.S. Application Data
(60) Provisional application No. 63/529,076, filed on Jul. 26, 2023.

(51) Int. Cl. H04S 7/00

(52) U.S. Cl. CPC H04S 7/40; H04S 7/301; H04S 2400/11; H04S 2420/01

(57) ABSTRACT

An apparatus that facilitates and/or supports stabilizing apparent azimuth angles of audio signals in environments of varying acoustic fidelity may include an eyewear frame dimensioned to be worn by a user. The apparatus may also include circuitry coupled to the eyewear frame and configured to (1) obtain an audio signal originating from a sound source in an environment of the user, (2) manipulate an azimuthal angle of the audio signal relative to a location of the sound source in the environment toward a midline feature of the user, and (3) provide the audio signal for auditory display to the user such that the manipulated azimuthal angle causes the user to perceive the audio signal as originating from the location of the sound source. Various other apparatuses, systems, and methods are also disclosed.

### PRIORITY CLAIM

This application claims the benefit of U.S. Provisional Application No. 63/529,076 filed Jul. 26, 2023, the disclosure of which is incorporated in its entirety by this reference.

### BRIEF DESCRIPTION OF DRAWINGS

The accompanying drawings illustrate a number of example embodiments and are a part of the specification. Together with the following description, these drawings demonstrate and explain various principles of the instant disclosure.

FIG. 1 is an illustration of an exemplary apparatus for stabilizing apparent azimuth angles of audio signals in environments of varying acoustic fidelity according to one or more implementations of this disclosure.

FIG. 2 is an illustration of an exemplary apparatus for stabilizing apparent azimuth angles of audio signals in environments of varying acoustic fidelity according to one or more implementations of this disclosure.

FIG. 3 is an illustration of an exemplary implementation of a system for stabilizing apparent azimuth angles of audio signals in environments of varying acoustic fidelity according to one or more implementations of this disclosure.

FIG. 4 is an illustration of an exemplary implementation of a system for stabilizing apparent azimuth angles of audio signals in environments of varying acoustic fidelity according to one or more implementations of this disclosure.

FIG. 5 is an illustration of an exemplary system for stabilizing apparent azimuth angles of audio signals in environments of varying acoustic fidelity according to one or more implementations of this disclosure.

FIG. 6 is a flow diagram of an exemplary method for stabilizing apparent azimuth angles of audio signals in environments of varying acoustic fidelity according to one or more implementations of this disclosure.

FIG. 7 is an illustration of exemplary augmented-reality glasses that may be used in connection with one or more implementations of this disclosure.

FIG. 8 is an illustration of an exemplary virtual-reality headset that may be used in connection with one or more implementations of this disclosure.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for stabilizing apparent azimuth angles of audio signals in environments of varying acoustic fidelity. As will be explained in greater detail below, these apparatuses, systems, and methods may provide numerous features and benefits.

In some examples, eyewear frames may facilitate, provide, and/or support artificial reality for users. Artificial reality may provide a rich, immersive experience in which users are able to interact with virtual objects and/or environments in one way or another. In this context, artificial reality may constitute and/or represent a form of reality that has been altered by virtual objects for presentation to a user. Such artificial reality may include and/or represent virtual reality (VR), augmented reality (AR), mixed reality, hybrid reality, or some combination and/or variation of one or more of the same.

In the absence of acoustic reflections, listeners may judge and/or perceive a sound source as being further to one side or the other than the true location of the sound source. This phenomenon may be observable in anechoic environments. Similarly, this phenomenon may affect and/or impact users of virtual (e.g., VR or AR) environments that include virtual sound sources, especially when the acoustics of the real-world environments occupied by the users differ from the acoustics implemented and/or modeled in the virtual environments. For example, users of virtual environments may experience and/or perceive the location of a virtual sound source as being somewhat misaligned and/or mismatched relative to the location of the visual representation of that sound source in such virtual environments. In another example, users of virtual environments may experience and/or perceive over-tracking, under-tracking, over-rotating, and/or under-rotating of audio originating from a virtual sound source. In other words, these users may experience and/or perceive sounds as moving too much and/or too far when the users' rotate their heads (e.g., as if the virtual environment were being counterrotated against their head turns).

To mitigate and/or eliminate spatial misalignment and/or spatial mismatching of the audio and video representations in environments of varying acoustic fidelity, the apparatuses, systems, and methods described herein may stabilize and/or align apparent azimuth angles of the audio signals. As a specific example, a user wearing an AR headset in an anechoic environment and/or an incompletely rendered virtual environment. In one example, the AR headset may include and/or represent circuitry that obtains, retrieves, and/or receives an audio signal that originates from a virtual sound source positioned proximate to the user in the environment. In this example, the circuitry may manipulate the azimuth of the audio signal relative to the position of the virtual sound source in the environment toward a midline feature of the user (e.g., the user's nose and/or back of the head). The circuitry may then provide the audio signal for auditory display to the user such that the manipulated azimuth causes the user to perceive the audio signal as originating from the true position of the virtual sound source as visually represented in the environment.

In some examples, the circuitry may implement and/or use a mathematical framework to compensate for the systematic perceptual errors of humans in assessing sound source locations and/or motions. For example, the circuitry may compress azimuths of audio signals toward the user's nose and/or expand such azimuths away from the user's ears. In this example, the circuitry may stabilize the azimuths of the audio signals by adjusting such azimuths in the amount of compression and/or expansion based at least in part on the acoustic fidelity of the room occupied by the user (e.g., early audio reflections) and/or the corresponding virtual model developed by the circuitry. In this way, the audio signals perceived by the user may be more faithfully tracked with respect to the user's head movements, as compared to other head-mounted displays, regardless of the accuracy of the room acoustics engine being used to develop the virtual model.

In some examples, the audio signals may each have and/or exhibit an angle relative to the user. In one example, the circuitry may apply an azimuth stabilization function, acoustic transfer function, array transfer function, and/or head-related transfer function to the audio signals to convert and/or correct the angles of the audio signals to provide an accurate perception of the sound source's location in the environment. In this example, the circuitry may output the audio signals with the corrected angle to the user so that the user perceives the audio signals as having come from the sound source located at those angles relative to the user. In certain implementations, the sound source may include and/or represent someone or something generating sound in the physical environment occupied by the user and/or in the virtual and/or augmented environment created and/or modeled for the user.

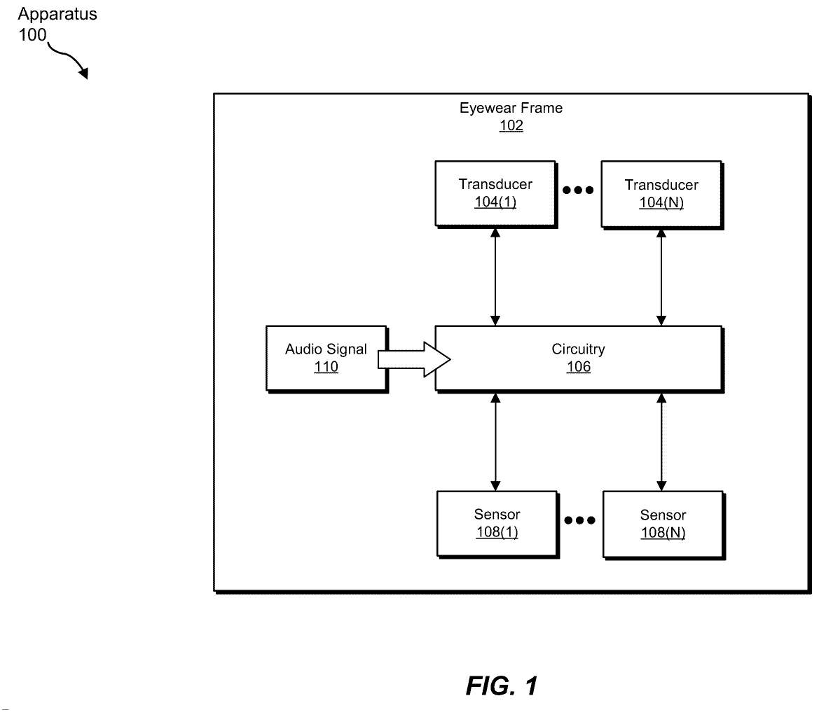

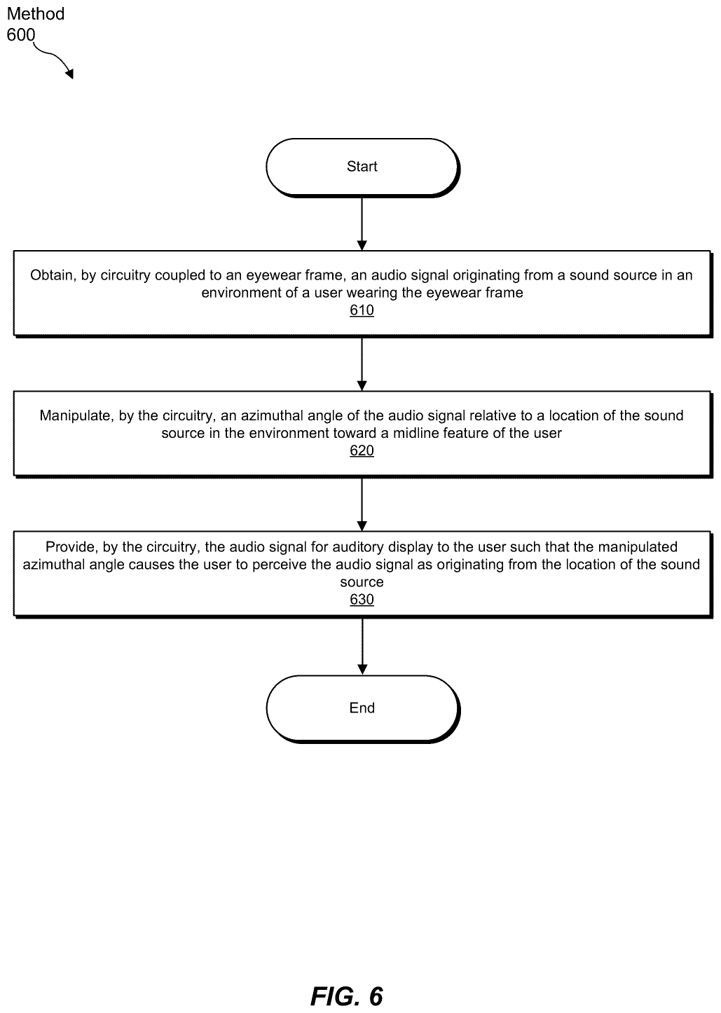

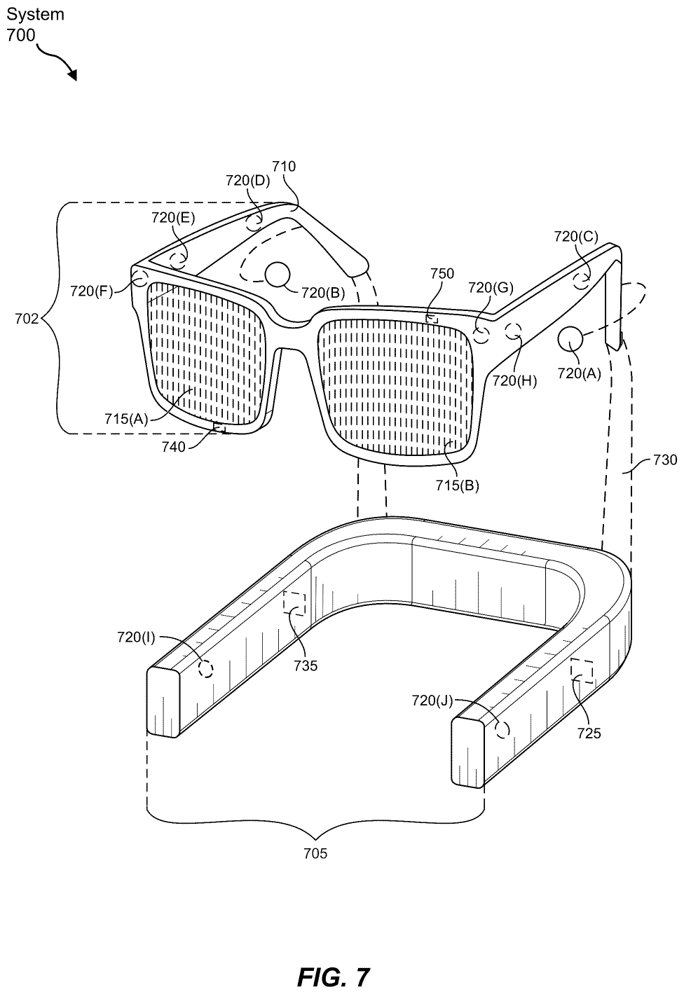

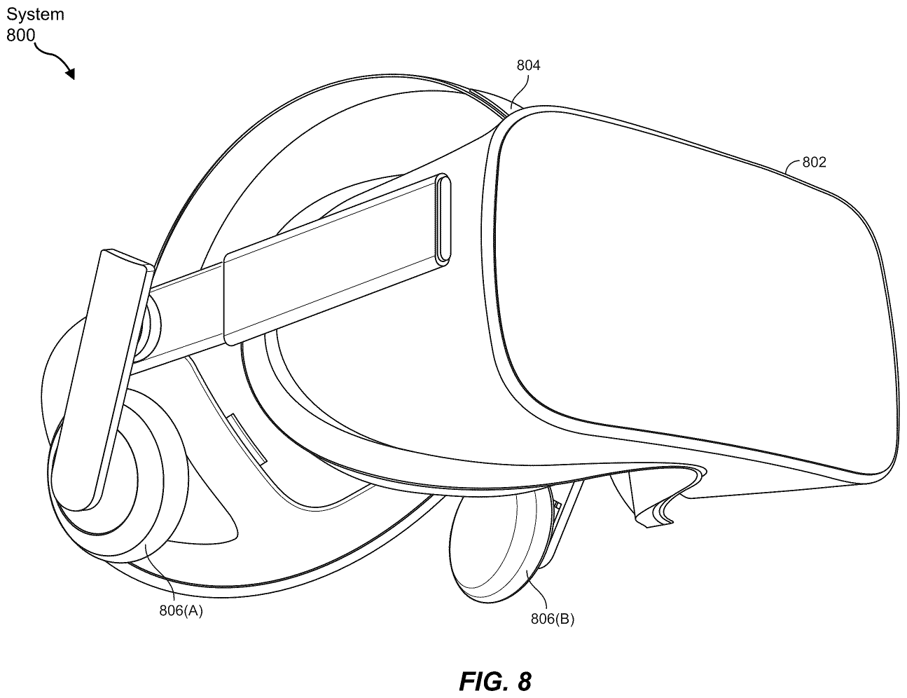

The following will provide, with reference to FIGS. 1-5, detailed descriptions of exemplary apparatuses, devices, systems, components, and corresponding configurations or implementations for stabilizing apparent azimuth angles of audio signals in environments of varying acoustic fidelity. In addition, detailed descriptions of methods for stabilizing apparent azimuth angles of audio signals in environments of varying acoustic fidelity will be provided in connection with FIG. 6. The discussion corresponding to FIGS. 7 and 8 will provide detailed descriptions of types of exemplary artificial-reality devices, wearables, and/or associated systems capable of stabilizing apparent azimuth angles of audio signals in environments of varying acoustic fidelity.

FIG. 1 illustrates an exemplary apparatus 100 for stabilizing apparent azimuth angles of audio signals in environments of varying acoustic fidelity. As illustrated in FIG. 1, apparatus 100 may include and/or represent an eyewear frame 102 dimensioned to be worn by a user. In some examples, eyewear frame 102 may include and/or be equipped with one or more transducers 104(1)-(N), circuitry 106, and/or one or more sensors 108(1)-(N). In one example, circuitry 106 may be physically coupled and/or secured to eyewear frame 102. In this example, circuitry 106 may obtain, retrieve, and/or receive an audio signal 110 from a sound source in an environment of the user.

In some examples, circuitry 106 may manipulate, modify, and/or correct an azimuthal angle of audio signal 110 relative to the location of the sound source in the environment toward a midline feature of the user (e.g., the user's nose and/or back of the head). In one example, circuitry 106 may provide audio signal 110 for auditory display to the user such that the manipulated azimuthal angle causes the user to perceive audio signal 110 as originating from the true and/or accurate location of the sound source in the environment. For example, circuitry 106 may provide and/or deliver audio signal 110 to transducers 104(1)-(N) for auditory display to the user.

In some examples, transducers 104(1)-(N) may be physically coupled and/or secured to eyewear frame 102. Additionally or alternatively, transducers 104(1)-(N) may be electrically and/or communicatively coupled to circuitry 106. In one example, transducers 104(1)-(N) may include and/or represent input and/or output devices implemented and/or incorporated in eyewear frame 102. For example, transducers 104(1)-(N) may include and/or represent one or more audio speakers and/or microphones. Examples of transducers 104(1)-(N) include, without limitation, voice coil speakers, ribbon speakers, electrostatic speakers, piezoelectric speakers, bone conduction transducers, cartilage conduction transducers, tragus-vibration transducers, tissue transducers, condenser microphones, dynamic microphones, ribbon microphones, combinations or variations of one or more of the same, and/or any other suitable transducers.

In some examples, sensors 108(1)-(N) may be physically coupled and/or secured to eyewear frame 102. Additionally or alternatively, sensors 108(1)-(N) may be electrically and/or communicatively coupled to circuitry 106. In one example, sensors 108(1)-(N) may generate, create, and/or provide data about imagery, visuals, motion, and/or audio in the environment occupied by the user. Examples of sensors 108(1)-(N) include, without limitation, photoplethysmogram (PPG) sensors, inertial measurement units (IMUs), electromyography (EMG) sensors, gyroscopes, accelerometers, optical or image sensors, cameras, input transducers, microphones, sound or decibel meters, radar devices, combinations or variations of one or more of the same, and/or any other suitable sensors.

In some examples, circuitry 106 may include and/or represent one or more electrical and/or electronic circuits capable of processing, applying, modifying, transforming, displaying, transmitting, receiving, and/or executing data for apparatus 100. In one example, circuitry 106 may process and/or analyze audio signal reflections detected, sensed, and/or received by sensors 108(1)-(N). Additionally or alternatively, circuitry 106 may implement, apply, and/or modify certain audio or visual features presented to the user wearing eyewear frame 102. In certain implementations, circuitry 106 may provide this audio or visual content for presentation on a display device and/or transducers 104(1)-(N) such that the audio or visual content is sensed, consumed, and/or experienced by the user.

In some examples, circuitry 106 may launch, perform, and/or execute certain executable files, code snippets, and/or computer-readable instructions to facilitate and/or support stabilizing apparent azimuth angles of audio signals in environments of varying acoustic fidelity. Although illustrated as a single unit in FIG. 1, circuitry 106 may include and/or represent a collection of multiple processing units and/or electrical or electronic components that work and/or operate in conjunction with one another. In one example, circuitry 106 may include and/or represent an application-specific integrated circuit (ASIC). In another example, circuitry 106 may include and/or represent a central processing unit (CPU).

Examples of circuitry 106 include, without limitation, processing devices, microprocessors, microcontrollers, graphics processing units (GPUs), field-programmable gate arrays (FPGAs), systems on chips (SoCs), parallel accelerated processors, tensor cores, integrated circuits, chiplets, optical modules, receivers, transmitters, transceivers, optical modules, memory devices, transistors, antennas, resistors, capacitors, diodes, inductors, switches, registers, flipflops, digital logic, connections, traces, buses, semiconductor (e.g., silicon) devices and/or structures, storage devices, audio controllers, portions of one or more of the same, variations or combinations of one or more of the same, and/or any other suitable circuitry.

In some examples, eyewear frame 102 may include and/or represent any type or form of structure and/or assembly capable of securing and/or mounting transducers 104(1)-(N), circuitry 106, and/or sensors 108(1)-(N) to the user's head or face. In one example, eyewear frame 102 may be sized, dimensioned, and/or shaped in any suitable way to facilitate securing and/or mounting an artificial-reality device to the user's head or face. In one example, eyewear frame 102 may include and/or contain a variety of different materials. Additional examples of such materials include, without limitation, plastics, acrylics, polyesters, metals (e.g., aluminum, magnesium, etc.), nylons, conductive materials, rubbers, neoprene, carbon fibers, composites, combinations or variations of one or more of the same, and/or any other suitable materials.

In some examples, apparatus 100 may include and/or represent a head-mounted display (HMD). In one example, the term “head-mounted display” and/or the abbreviation “HMD” may refer to any type or form of display device or system that is worn on or about a user's face and displays virtual content, such as computer-generated objects and/or AR content, to the user. HMDs may present and/or display content in any suitable way, including via a display screen, a liquid crystal display (LCD), a light-emitting diode (LED), a microLED display, a plasma display, a projector, a cathode ray tube, an optical mixer, combinations or variations of one or more of the same, and/or any other suitable HMDs. HMDs may present and/or display content in one or more media formats. For example, HMDs may display video, photos, computer-generated imagery (CGI), and/or variations or combinations of one or more of the same. Additionally or alternatively, HMDs may include and/or incorporate see-through lenses that enable the user to see the user's surroundings in addition to such computer-generated content.

HMDs may provide diverse and distinctive user experiences. Some HMDs may provide virtual reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through lenses), which may result in AR and/or mixed reality experiences.

In some examples, the sound source may include and/or represent a location and/or position of a sound-making element and/or feature within the virtual and/or augmented environment of the user. For example, the sound source may include and/or represent a virtual avatar of a singer and/or guitar player present in the virtual and/or augmented environment of the user. In this example, audio signal 110 may constitute and/or represent sounds and/or noises corresponding to the singer and/or guitar player. In other words, the sounds and/or noises produced by audio signal 110 should appear to originate from and/or to be made by the signer and/or guitar player.

In some examples, the sound source may include and/or represent a memory and/or storage device in which a file and/or data containing audio signal 110 resides and/or is stored. In this example, audio signal 110 may correspond to and/or be associated with visual and/or virtual content or data configured for visual presentation and/or display to the user.

Additionally or alternatively, the sound source may include and/or represent a device, component, and/or feature that is separate, remote, and/or distinct from eyewear frame 102, circuitry 106, and/or apparatus 100. In one example, the sound source may include and/or represent a network device, component, and/or feature that streams audio signal 110 to eyewear frame 102, circuitry 106, and/or apparatus 100. In this example, audio signal 110 may correspond to and/or be associated with visual and/or virtual content or data being streamed from the sound source for presentation and/or display to the user.

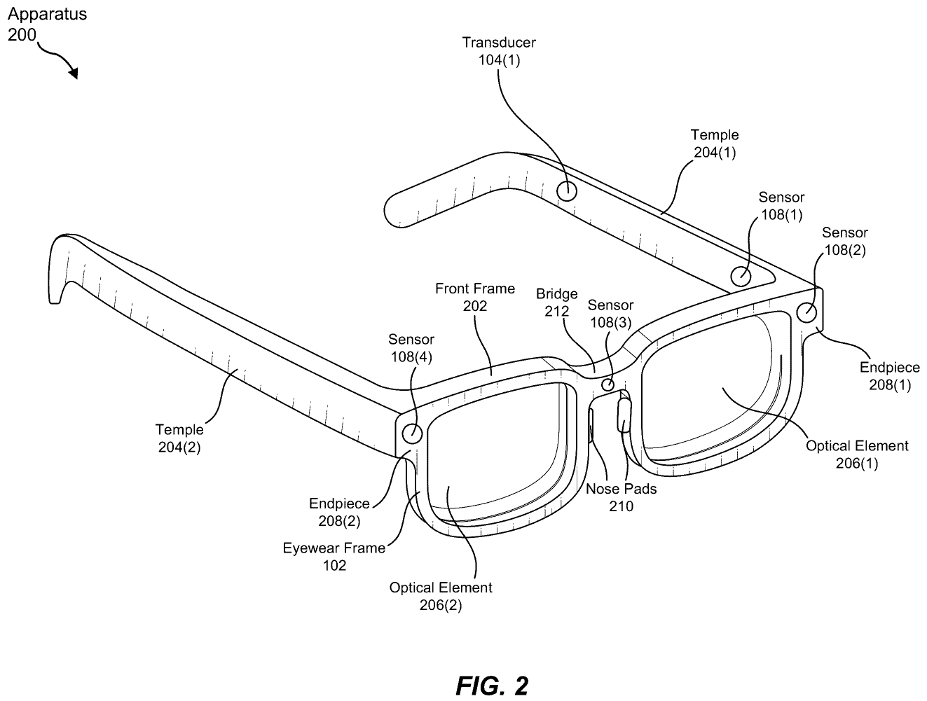

FIG. 2 illustrates an exemplary apparatus 200 for stabilizing apparent azimuth angles of audio signals in environments of varying acoustic fidelity. In some examples, apparatus 200 may include and/or represent certain devices, components, and/or features that perform and/or provide functionalities that are similar and/or identical to those described above in connection with FIG. 1. As illustrated in FIG. 2, apparatus 200 may include and/or represent eyewear frame 102 that facilitates and/or supports stabilizing apparent azimuth angles of audio signals in environments of varying acoustic fidelity. In one example, eyewear frame 102 may include and/or represent a front frame 202, temples 204(1) and 204(2), optical elements 206(1) and 206(2), endpieces 208(1) and 208(2), nose pads 210, and/or a bridge 212. Additionally or alternatively, eyewear frame 102 may include, implement, and/or incorporate transducers 104(1)-(N), circuitry 106, and/or sensors 108(1)-(N)—some of which are not necessarily illustrated, visible, and/or labelled in FIG. 2.

In some examples, transducer 104(1) and/or sensor 108(1) may be coupled to, secured to, and/or integrated into temple 204(1) of eyewear frame 102. In one example, transducer 104(1) and/or sensor 108(1) may be aimed and/or directed toward the user's head when eyewear frame 102 is worn by the user. Similar or identical transducers and/or sensors may be coupled to, secured to, and/or integrated into temple 204(2) of eyewear frame 102.

In some examples, sensors 108(2), 108(3), and/or 108(4) may be coupled to, secured to, and/or integrated into front frame 202 of eyewear frame 102. In one example, sensors 108(2), 108(3), and/or 108(4) may be aimed and/or directed away from the user's head when eyewear frame 102 is worn by the user.

In some examples, optical elements 206(1) and 206(2) may be inserted and/or installed in front frame 202. In other words, optical elements 206(1) and 206(2) may be coupled to, incorporated in, and/or held by eyewear frame 102. In one example, optical elements 206(1) and 206(2) may be configured and/or arranged to provide one or more virtual visual features for presentation to a user wearing apparatus 200. These virtual visual features may be driven, influenced, and/or controlled by one or more wireless technologies supported by apparatus 200.

In some examples, optical elements 206(1) and 206(2) may each include and/or represent optical stacks, lenses, and/or films. In one example, optical elements 206(1) and 206(2) may each include and/or represent various layers that facilitate and/or support the presentation of virtual features and/or elements that overlay real-world features and/or elements. Additionally or alternatively, optical elements 206(1) and 206(2) may each include and/or represent one or more screens, lenses, and/or fully or partially see-through components. Examples of optical elements 206(1) and 206(2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

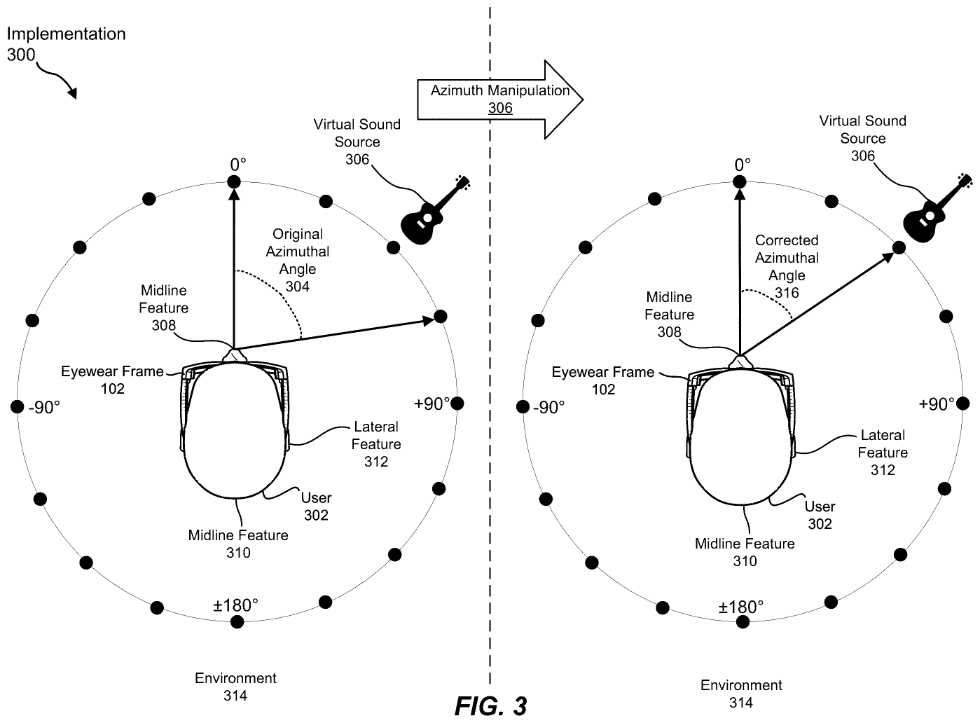

FIG. 3 illustrates an exemplary implementation 300 of a system for stabilizing apparent azimuth angles of audio signals in environments of varying acoustic fidelity. In some examples, implementation 300 may include, involve, and/or represent certain devices, components, and/or features that perform and/or provide functionalities that are similar and/or identical to those described above in connection with either FIG. 1 or FIG. 2. As illustrated in FIG. 3, a user 302 may wear and/or don eyewear frame 102. In one example, implementation 300 may involve an audio signal corresponding to and/or being associated with a virtual sound source 306 in an environment 314. In this example, the azimuth of the audio signal may be manipulated, moved, rotated, and/or corrected so that user 302 perceives the audio signal as having originated from the true and/or accurate location of virtual sound source 306.

In some examples, circuitry 106 may manipulate, move, and/or correct the azimuthal angle of the audio signal toward a midline feature 308 or 310 and/or away from a lateral feature 312. For example, circuitry 106 may manipulate, move, and/or correct the azimuthal angle of the audio signal toward the user's nose (0°) or the back of the user's head (e.g., ±180°). In this example, circuitry 106 may compress the azimuthal angle of the audio signal toward the user's nose (0°) or the back of the user's head (±180°) in environment 314. Additionally or alternatively, circuitry 106 may expand the azimuthal angle of the audio signal away from the user's ears (±90°) in environment 314.

In some examples, sensors 108(1)-(N) may sense, detect, and/or measure movements of the user's head. In one example, circuitry 106 may manipulate, move, and/or correct the azimuthal of the audio signal toward midline feature 308 or 310 and/or away from lateral feature 312 to account for the location of virtual sound source 306 in view of and/or in response to the movement of the user's head. In other words, circuitry 106 may modify the azimuthal angle of the audio signal to account and/or compensate for the user's head movement based at least in part on the measurements taken by sensors 108(1)-(N).

In some examples, circuitry 106 may manipulate, move, and/or correct the azimuthal angle of the audio signal by applying a transfer function (e.g., an acoustic transfer function, array transfer function, and/or head-related transfer function) to the audio signal. In one example, circuitry 106 may calibrate the transfer function to user 302. For example, circuitry 106 may obtain and/or receive input provided and/or entered by user 302 via a user interface. In this example, circuitry 106 may calibrate the transfer function applied to the audio signal based at least in part on the input. In certain implementations, such input may include and/or represent one or more preferences of the user.

In some examples, circuitry 106 may obtain, retrieve, and/or receive the audio signal that is supposed to be presented as having originated from virtual sound source 306 in environment 314. However, in one example, the audio signal may have and/or exhibit an original azimuthal angle 304 that corresponds to and/or represents a direction and/or origin that deviates from the location of virtual sound source 306. As a result, if the audio signal were presented to user 302 with original azimuthal angle 304, then user 302 may perceive and/or sense the audio signal as having originated from a location that fails to coincide, match, and/or align with virtual sound source 306. In this example, circuitry 106 may implement and/or apply a transfer function that manipulates, moves, and/or corrects the azimuth of the audio signal, resulting in a corrected azimuthal angle 316 that corresponds to and/or represents a direction and/or origin that coincides, matches, and/or aligns with virtual sound source 306. By doing so, circuitry 106 may ensure that the audio signal appears to have originated from virtual sound source 306 to user 302.

In some examples, the manipulation of the audio azimuth may effectively constitute and/or represent a type of warping applied to the apparent locations of spatial audio sources. Such warping may be based at least in part on the user's head movement, the speed and/or velocity of real or virtual objects, and/or the elevation or rotation of the virtual sound source 306 relative to user 302.

In some examples, the manipulation of the audio azimuth may effectively constitute and/or represent a type of warping applied to the apparent locations of spatial audio sources in view of room acoustics. Such warping may be based at least in part on the quality of the room simulation, the amount of reverb and/or characteristics of the environment, the quality of the audio in the environment, the source being voiced and/or emitting sound, and/or the duration and/or intensity of the sound. Additionally or alternatively, such warping may be applied to both objects and ambisonics sources (in the same way or in different ways).

Various transfer functions may be used and/or applied to original azimuth angle 304 to achieve, reach, and/or find corrected azimuth angle 316. In some examples, one transfer function capable of correcting original azimuthal angle 304 of the audio signal may involve identifying original azimuthal angle 304 of the audio signal, calculating a product by multiplying a compression constant by a sine function of double original azimuthal angle 304, and then subtracting the product from original azimuthal angle 304 to find corrected azimuthal angle 316. As a specific example, a transfer function capable of correcting original azimuthal angle 304 of the audio signal may be represented as θ′=θ−R*sin(2θ), where θ is original azimuthal angle 304, θ′ is corrected azimuthal angle 316, and R is a compression constant. In this example, as the value of R increases, the angle between the user's midline to virtual sound source 306 decreases. In certain implementations, R may vary between 1 and 10.

In some examples, another transfer function capable of correcting original azimuthal angle 304 of the audio signal may involve identifying original azimuthal angle 304 of the audio signal, calculating an inverse hyperbolic tangent of an input involving original azimuthal angle 304, and then multiplying the inverse hyperbolic tangent by at least one constant. As a specific example, another transfer function capable of correcting original azimuthal angle 304 of the audio signal may be represented as

$${θ}^{′} = \frac{90 * ln ( 10 ) * {tan}^{- 1} ( \frac{θ * tanh ( \frac{ln ( R * t - c )}{ln ( 10 )} )}{90} )}{ln ( R * t - c )} ,$$

where θ is original azimuthal angle 304, θ′ is corrected azimuthal angle 316, R is a compression constant, t is a constant, and c is a constant. In this example, as the value of R increases, the angle between the user's midline to virtual sound source 306 decreases. In certain implementations, R may vary between 1 and 4, t may equal 7.08, and/or c may equal 5.97.

In some examples, environment 314 may include and/or represent the physical environment and/or room occupied by the user, a virtual environment implemented by a VR HMD, and/or an augmented environment implemented by an AR HMD. In one example, virtual sound source 306 may be implemented and/or rendered near and/or proximate to user 302 in environment 314. Additionally or alternatively, environment 314 may constitute and/or represent a reproduction model of the acoustics of a room occupied by user 302. Furthermore, environment 314 may be anechoic and/or may be configured to run or house an audio system that operates anechoically or relies on highly simplified acoustical approximations for a room (e.g., for computational or memory-saving reasons).

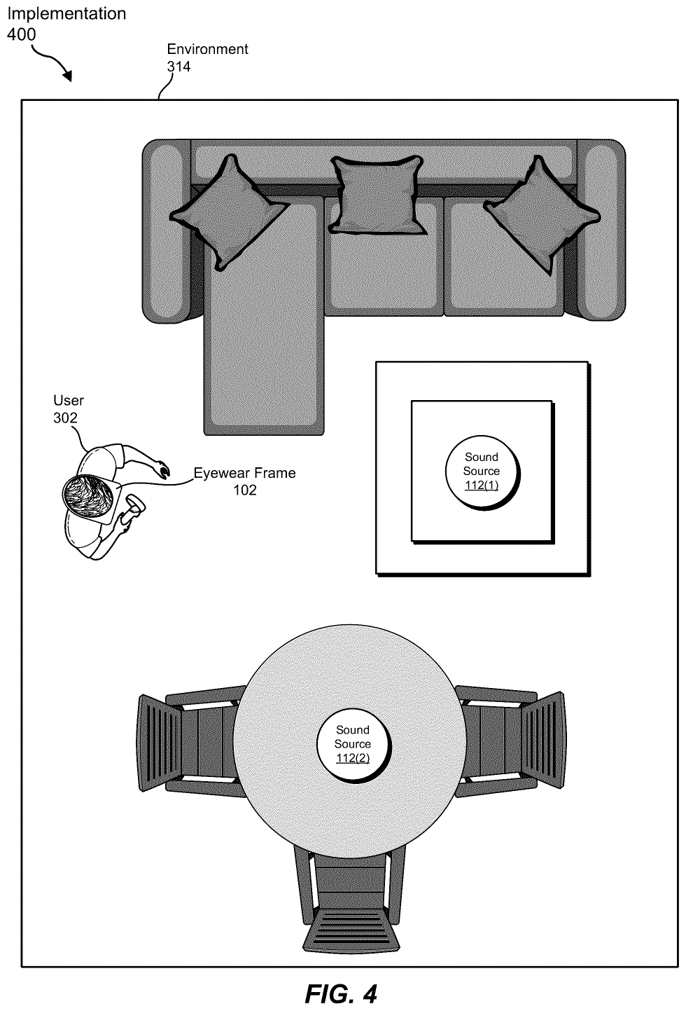

FIG. 4 illustrates an exemplary implementation 400 of a system for stabilizing apparent azimuth angles of audio signals in environments of varying acoustic fidelity. In some examples, implementation 400 may include, involve, and/or represent certain devices, components, and/or features that perform and/or provide functionalities that are similar and/or identical to those described above in connection with any of FIGS. 1-3. As illustrated in FIG. 4, user 302 may wear and/or don eyewear frame 102. In one example, implementation 400 may involve an audio signal corresponding to and/or being associated with virtual sound source 306 and/or sound sources 112(1)-(2) in an environment 314. In this example, the azimuth of the audio signal may be manipulated, moved, rotated, and/or corrected so that user 302 perceives the audio signal as having originated from the true and/or accurate location of virtual sound source 306 in environment 314.

In some examples, sensors 108(1)-(N) may sense, detect, and/or measure audio reflections in environment 314 and/or in the room occupied by user 302. Additionally or alternatively, sensors 108(1)-(N) may sense, detect, and/or measure sounds produced by one or more of sound sources 112(1)-(2) in environment 314 and/or in the room occupied by user 302. In one example, sensors 108(1)-(N) may sense, detect, and/or measure audio information representative of an acoustics provide of environment 314 and/or in the room occupied by user 302.

In some examples, circuitry 106 may generate, create, and/or simulate an acoustics model of environment 314 based at least in part on the sounds, measurements, and/or audio information obtained and/or received from sensors 108(1)-(N). In one example, circuitry 106 may also manipulate, modify, and/or correct the azimuthal angle of the audio signal to account for the acoustics model of the environment.

In some examples, although not necessarily illustrated in this way in FIG. 4, sound sources 112(1)-(2) may each include and/or represent any type or form of output transducer (e.g., a speaker) coupled to eyewear frame 102. Additionally or alternatively, sound sources 112(1)-(2) may each include and/or represent an object located in the room occupied by user 302.

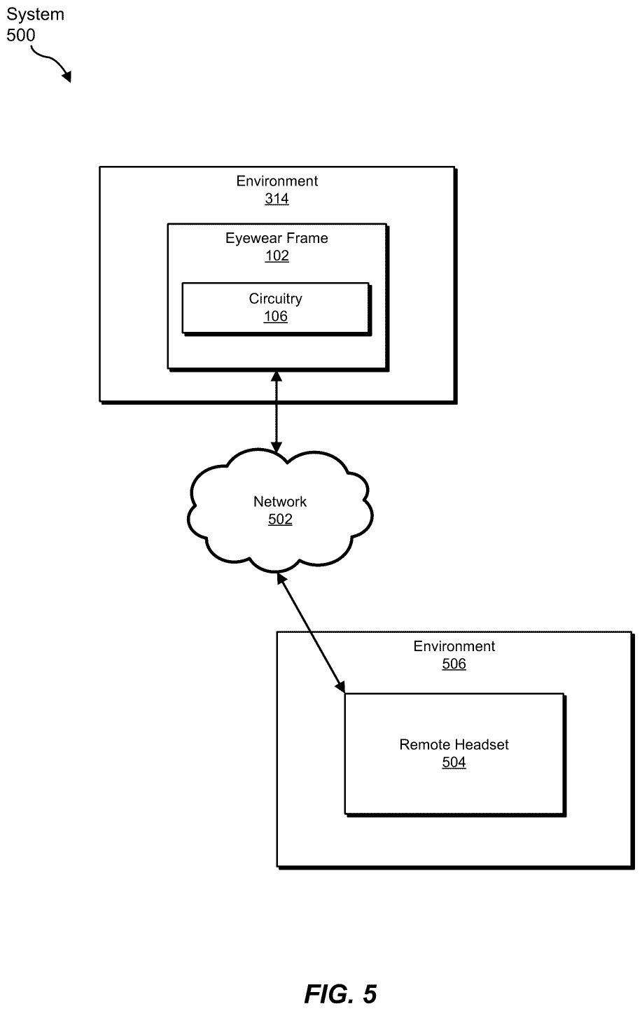

FIG. 5 illustrates an exemplary system 500 for stabilizing apparent azimuth angles of audio signals in environments of varying acoustic fidelity. In some examples, system 500 may include, involve, and/or represent certain devices, components, and/or features that perform and/or provide functionalities that are similar and/or identical to those described above in connection with any of FIGS. 1-4. As illustrated in FIG. 5, system 500 may include and/or represent eyewear frame 102 running in environment 314 and a remote headset 504 running in an environment 506, and eyewear frame 102 and remote headset 504 may be communicatively coupled via a network 502. In one example, eyewear frame 102 may be worn and/or donned by user 302 occupying environment 314, and remote headset 504 may be worn and/or donned by another user occupying environment 506. In this example, remote headset 504 may include and/or represent an AR/VR HMD that is similar and/or identical to apparatus 100 or 200.

In some examples, environment 506 may include and/or represent the physical environment and/or room occupied by the other user wearing remote headset 504, a virtual environment implemented by remote headset 504, and/or an augmented environment implemented by remote headset 504. In one example, one or more of sound sources 112(1)-(2) and/or virtual sound source 306 may generate, produce, and/or correspond to sounds and/or audio signals that are passed and/or transferred from eyewear frame 102 to remote headset 504 via network 502. In this example, remote headset 504 may provide sounds and/or audio signals for auditory display to the other user.

In some examples, remote headset 504 may present and/or display sounds and/or audio signals in connection and/or conjunction with one or more virtual visual representations. For example, remote headset 504 may generate, produce, and/or render a virtual visual representation of user 302 for viewing and/or experiencing by the other user in an AR-conferencing application. In this example, remote headset 504 may provide sounds and/or audio signals for auditory display to the other user in connection and/or conjunction with the virtual visual representation of user 302.

In some examples, the AR-conferencing application may set, place, and/or position the virtual visual representation of user 302 in environment 506 via remote headset 504. In one example, circuitry 106 may manipulate, move, and/or correct the azimuths of the sounds and/or audio signals prior to transmitting the same to remote headset 504 via network 502. Additionally or alternatively, remote headset 504 may manipulate, move, and/or correct the azimuth of the sounds and/or audio signals after receiving the same from eyewear frame 102 via network 502. In this example, remote headset 504 may be able to spatially align and/or spatially match the sounds and/or audio signals to the setting, placement, and/or position of the virtual visual representation of user 302 in environment 506. Accordingly, remote headset 504 may be able to provide the sounds and/or audio signals for auditory display to the other user such that the corrected azimuths cause the other user to perceive the sounds and/or audio signals as originating from the true setting, placement, and/or position of the virtual visual representation of user 302 in environment 506.

In some examples, the various apparatuses, devices, and systems described in connection with FIGS. 1-5 may include and/or represent one or more additional circuits, components, and/or features that are not necessarily illustrated and/or labeled in FIGS. 1-5. For example, the apparatuses, devices, and systems illustrated in FIGS. 1-5 may also include and/or represent additional analog and/or digital circuitry, onboard logic, transistors, radio-frequency (RF) transmitters, RF receivers, RF transceivers, antennas, resistors, capacitors, diodes, inductors, switches, registers, flipflops, digital logic, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-5 consistent with the aims and/or objectives described herein. Accordingly, the couplings and/or connections described with reference to FIGS. 1-5 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

In some examples, one or more components and/or features illustrated in FIGS. 1-5 may be excluded and/or omitted from the various apparatuses, devices, and/or systems described in connection with FIGS. 1-5. For example, although FIG. 1 illustrates apparatus 100 as including sensors 108(1)-(N), alternative implementations of apparatus 100 may exclude and/or omit sensors 108(1)-(N) altogether.

FIG. 6 is a flow diagram of an exemplary method 600 for configuring, assembling, and/or programming apparatuses, devices, or systems capable of stabilizing apparent azimuth angles of audio signals in environments of varying acoustic fidelity. In one example, the steps shown in FIG. 6 may be achieved and/or accomplished by an AR/VR HMD worn by a user. Additionally or alternatively, the steps shown in FIG. 6 may incorporate and/or involve certain sub-steps and/or variations consistent with the descriptions provided above in connection with FIGS. 1-5.

As illustrated in FIG. 6, method 600 may include the step of obtaining, by circuitry coupled to an eyewear frame, an audio signal originating from a sound source in an environment of a user wearing the eyewear frame (610). Step 610 may be performed in a variety of ways, including any of those described above in connection with FIGS. 1-5. For example, circuitry incorporated in an AR/VR HMD may obtain an audio signal originating from a sound source in an environment of a user wearing the eyewear frames.

Method 600 may also include the step of manipulating, by the circuitry, an azimuthal angle of the audio signal relative to a location of the sound source in the environment toward a midline feature of the user (620). Step 620 may be performed in a variety of ways, including any of those described above in connection with FIGS. 1-5. For example, the circuitry incorporated in the AR/VR HMD may manipulate an azimuthal angle of the audio signal relative to a location of the sound source in the environment toward a midline feature of the user.

Method 600 may further include the step of providing, by the circuitry, the audio signal for auditory display to the user such that the manipulated azimuthal angle causes the user to perceive the audio signal as originating from the location of the sound source (630). Step 630 may be performed in a variety of ways, including any of those described above in connection with FIGS. 1-5. For example, the circuitry incorporated in the AR/VR HMD may provide the audio signal for auditory display to the user such that the manipulated azimuthal angle causes the user to perceive the audio signal as originating from the location of the sound source.

### Example Embodiments

Example 1: An apparatus comprising (1) an eyewear frame dimensioned to be worn by a user and (2) circuitry coupled to the eyewear frame and configured to (A) obtain an audio signal originating from a sound source in an environment of the user, (B) manipulate an azimuthal angle of the audio signal relative to a location of the sound source in the environment toward a midline feature of the user, and (C) provide the audio signal for auditory display to the user such that the manipulated azimuthal angle causes the user to perceive the audio signal as originating from the location of the sound source.

Example 2: The apparatus of Example 1, further comprising one or more sensors coupled to the eyewear frame and configured to detect movement of a head of the user, wherein the circuitry is further configured to manipulate the azimuthal angle of the audio signal to account for the location of the sound source in view of the movement of the head of the user.

Example 3: The apparatus of either Example 1 or Example 2, wherein the circuitry is further configured to manipulate the azimuthal angle of the audio signal by at least one of (1) compressing the azimuth angle of the audio signal toward the midline feature of the user or (2) expanding the azimuth angle of the audio signal away from a lateral feature of the user.

Example 4: The apparatus of any of Examples 1-3, wherein the midline feature of the user comprises a nose or an external occipital protuberance, and the lateral feature of the user comprises an ear.

Example 5: The apparatus of any of Examples 1-4, wherein the circuitry is further configured to manipulate the azimuthal angle of the audio signal by applying a transfer function to the audio signal.

Example 6: The apparatus of any of Examples 1-5, wherein the circuitry is further configured to calibrate the transfer function based at least in part on a preference of the user.

Example 7: The apparatus of any of Examples 1-6, wherein the circuitry is further configured to manipulate the azimuthal angle of the audio signal by (1) identifying an initial azimuthal angle of the audio signal, (2) calculating a product by multiplying a compression constant by a sine function of double the initial azimuthal angle, and (3) subtracting the product from the initial azimuthal angle.

Example 8: The apparatus of any of Examples 1-7, wherein the circuitry is further configured to manipulate the azimuthal angle of the audio signal by (1) identifying an initial azimuthal angle of the audio signal, (2) calculating an inverse hyperbolic tangent of an input involving the initial azimuthal angle, and (3) multiplying the inverse hyperbolic tangent by at least one constant.

Example 9: The apparatus of any of Examples 1-8, wherein the environment comprises a virtual or augmented environment, and the sound source comprises a virtual sound source implemented near the user in the virtual or augmented environment.

Example 10: The apparatus of any of Examples 1-9, further comprising one or more sensors coupled to the eyewear frame and configured to detect at least one of (1) sounds produced by one or more additional sound sources in the environment or (2) audio information representative an acoustics profile of the environment, and wherein the circuitry is further configured to (1) generate an acoustics model of the environment based at least in part on the sounds or the audio information and (2) manipulate the azimuthal angle of the audio signal to account for the acoustics model of the environment.

Example 11: The apparatus of any of Examples 1-10, wherein the additional sound sources comprise at least one of (1) a transducer coupled to the eyewear frame or (2) an object located in a room occupied by the user.

Example 12: A system comprising (1) an eyewear frame dimensioned to be worn by a user, (2) one or more sensors coupled to the eyewear frame and configured to detect movement of a head of the user, and (3) circuitry coupled to the eyewear frame and configured to (A) obtain an audio signal originating from a sound source in an environment of the user, (B) manipulate, based at least in part on the movement, an azimuthal angle of the audio signal relative to a location of the sound source in the environment toward a midline feature of the user, and (C) provide the audio signal for auditory display to the user such that the manipulated azimuthal angle causes the user to perceive the audio signal as originating from the location of the sound source.

Example 13: The system of Example 12, wherein the circuitry is further configured to manipulate the azimuthal angle of the audio signal by at least one of (1) compressing the azimuth angle of the audio signal toward the midline feature of the user or (2) expanding the azimuth angle of the audio signal away from a lateral feature of the user.

Example 14: The system of Example 12 or 13, wherein the midline feature comprises a nose of the user or an external occipital protuberance, and the lateral feature comprises an ear of the user.

Example 15: The system of any of Examples 12-14, wherein the circuitry is further configured to manipulate the azimuthal angle of the audio signal by applying a transfer function to the audio signal.

Example 16: The system of any of Examples 12-15, wherein the circuitry is further configured to calibrate the transfer function based at least in part on a preference of the user.

Example 17: The system of any of Examples 12-16, wherein the circuitry is further configured to manipulate the azimuthal angle of the audio signal by (1) identifying an initial azimuthal angle of the audio signal, (2) calculating a product by multiplying a compression constant by a sine function of double the initial azimuthal angle, and (3) subtracting the product from the initial azimuthal angle.

Example 18: The system of any of Examples 12-17, wherein the circuitry is further configured to manipulate the azimuthal angle of the audio signal by (1) identifying an initial azimuthal angle of the audio signal, (2) calculating an inverse hyperbolic tangent of an input involving the initial azimuthal angle, and (3) multiplying the inverse hyperbolic tangent by at least one constant.

Example 19: The system of any of Examples 12-18, wherein (1) the environment comprises a virtual or augmented environment, and (2) the sound source comprises a virtual sound source implemented near the user in the virtual or augmented environment.

Example 20: A method comprising (1) obtaining, by circuitry coupled to an eyewear frame, an audio signal originating from a sound source in an environment of the user, (2) manipulating, by the circuitry, an azimuthal angle of the audio signal relative to a location of the sound source in the environment toward a midline feature of the user, and (3) providing, by the circuitry, the audio signal for auditory display to the user such that the manipulated azimuthal angle causes the user to perceive the audio signal as originating from the location of the sound source.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a 3D effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(I) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), AR system 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(I) and 720(J)) that are part of the microphone array (or potentially form their own microphone subarray). Neckband 705 may also include a controller 725 and a power source 735.

Acoustic transducers 720(1) and 720(J) of neckband 705 may be configured to detect sound and convert the detected sound into an electronic format (analog or digital). In the embodiment of FIG. 7, acoustic transducers 720(I) and 720(J) may be positioned on neckband 705, thereby increasing the distance between the neckband acoustic transducers 720(I) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium-ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application.

Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of an online social network may specify privacy settings for a user-profile page that identify a set of users that may access work-experience information on the user-profile page, thus excluding other users from accessing that information.

In some embodiments, privacy settings for an object may specify a “blocked list” of users or other entities that should not be allowed to access certain information associated with the object. In some cases, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In some embodiments, privacy settings may be associated with particular social-graph elements.

Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In some embodiments, privacy settings may allow users to opt in to or opt out of having their content, information, or actions stored/logged by a social-networking system or shared with other systems (e.g., a third-party system). Although this disclosure describes using particular privacy settings in a particular manner, this disclosure contemplates using any suitable privacy settings in any suitable manner.

In some embodiments, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network.

Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In some embodiments, a social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In some embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In some embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In some embodiments, an object may represent content that is visible to a user through a newsfeed of the user. As an example and not by way of limitation, one or more objects may be visible to a user's “Trending” page. In some embodiments, an object may correspond to a particular user. The object may be content associated with the particular user or may be the particular user's account or information stored on the social-networking system or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In some embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In some embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In some embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In some embodiments, privacy settings may allow a first user to specify (e.g., by opting out, by not opting in) whether the social-networking system may receive, collect, log, or store particular objects or information associated with the user for any purpose. In some embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In some embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In some embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

### Privacy Settings for Mood, Emotion, or Sentiment Information

In some embodiments, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. For example, a social-networking system may predict or determine a mood, emotion, or sentiment associated with a user based on, for example, inputs provided by the user and interactions with particular objects, such as pages or content viewed by the user, posts or other content uploaded by the user, and interactions with other content of the online social network.

In some embodiments, the social-networking system may use a user's previous activities and calculated moods, emotions, or sentiments to determine a present mood, emotion, or sentiment. A user who wishes to enable this functionality may indicate in their privacy settings that they opt in to the social-networking system receiving the inputs necessary to determine the mood, emotion, or sentiment. As an example, the social-networking system may determine that a default privacy setting is to not receive any information necessary for determining mood, emotion, or sentiment until there is an express indication from a user that the social-networking system may do so. By contrast, if a user does not opt in to the social-networking system receiving these inputs (or affirmatively opts out of the social-networking system receiving these inputs), the social-networking system may be prevented from receiving, collecting, logging, or storing these inputs or any information associated with these inputs. In some embodiments, the social-networking system may use the predicted mood, emotion, or sentiment to provide recommendations or advertisements to the user.

In some embodiments, if a user desires to make use of this function for specific purposes or applications, additional privacy settings may be specified by the user to opt in to using the mood, emotion, or sentiment information for the specific purposes or applications. As an example, the social-networking system may use the user's mood, emotion, or sentiment to provide newsfeed items, pages, friends, or advertisements to a user. The user may specify in their privacy settings that the social-networking system may determine the user's mood, emotion, or sentiment. The user may then be asked to provide additional privacy settings to indicate the purposes for which the user's mood, emotion, or sentiment may be used. The user may indicate that the social-networking system may use his or her mood, emotion, or sentiment to provide newsfeed content and recommend pages, but not for recommending friends or advertisements. The social-networking system may then only provide newsfeed content or pages based on user mood, emotion, or sentiment, and may not use that information for any other purpose, even if not expressly prohibited by the privacy settings.

### Privacy Settings for Ephemeral Sharing

In some embodiments, privacy settings may allow a user to engage in the ephemeral sharing of objects on an online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In some embodiments, for particular objects or information having privacy settings specifying that they are ephemeral, the social-networking system may be restricted in its access, storage, or use of the objects or information. The social-networking system may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the social-networking system may temporarily store the message in a data store until the second user has viewed or downloaded the message, at which point the social-networking system may delete the message from the data store. As another example and not by way of limitation, continuing with the prior example, the message may be stored for a specified period of time (e.g., 2 weeks), after which point the social-networking system may delete the message from the data store.

### Privacy Settings Based on Location

In some embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

### Privacy Settings for User-Authentication and Experience-Personalization Information

In some embodiments, a social-networking system may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system. The user's privacy settings may specify that such information may be used only for particular processes, such as authentication, and further specify that such information may not be shared with any third-party system or used for other processes or applications associated with the social-networking system. As another example and not by way of limitation, the social-networking system may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system or used by other processes or applications associated with the social-networking system. As another example and not by way of limitation, the social-networking system may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any third-party system or used by other processes or applications associated with the social-networking system.

### User-Initiated Changes to Privacy Settings

In some embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. A social-networking system may determine that this privacy setting also applies to the first image and make the first image visible only to the first user group. In some embodiments, the change in privacy settings may take effect only going forward. Continuing the example above, if the first user changes privacy settings and then shares a second image, the second image may be visible only to the first user group, but the first image may remain visible to all users. In some embodiments, in response to a user action to change a privacy setting, the social-networking system may further prompt the user to indicate whether the user wants to apply the changes to the privacy setting retroactively. In some embodiments, a user change to privacy settings may be a one-off change specific to one object. In some embodiments, a user change to privacy may be a global change for all objects associated with the user.

In some embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In some embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In some embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In some embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In some embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
an eyewear frame dimensioned to be worn by a user; and
circuitry coupled to the eyewear frame and configured to:
obtain an audio signal originating from a sound source in an environment of the user;
manipulate an azimuthal angle of the audio signal relative to a location of the sound source in the environment toward a midline feature of the user; and
provide the audio signal for auditory display to the user such that the manipulated azimuthal angle causes the user to perceive the audio signal as originating from the location of the sound source.

2. The apparatus of claim 1, further comprising one or more sensors coupled to the eyewear frame and configured to detect movement of a head of the user; and
wherein the circuitry is further configured to manipulate the azimuthal angle of the audio signal to account for the location of the sound source in view of the movement of the head of the user.

3. The apparatus of claim 1, wherein the circuitry is further configured to manipulate the azimuthal angle of the audio signal by at least one of:
compressing the azimuth angle of the audio signal toward the midline feature of the user; or
expanding the azimuth angle of the audio signal away from a lateral feature of the user.

4. The apparatus of claim 3, wherein:
the midline feature of the user comprises a nose or an external occipital protuberance; and
the lateral feature of the user comprises an ear.

5. The apparatus of claim 1, wherein the circuitry is further configured to manipulate the azimuthal angle of the audio signal by applying a transfer function to the audio signal.

6. The apparatus of claim 5, wherein the circuitry is further configured to calibrate the transfer function based at least in part on a preference of the user.

7. The apparatus of claim 1, wherein the circuitry is further configured to manipulate the azimuthal angle of the audio signal by:
identifying an original azimuthal angle of the audio signal;
calculating a product by multiplying a compression constant by a sine function of double the original azimuthal angle; and
subtracting the product from the original azimuthal angle.

8. The apparatus of claim 1, wherein the circuitry is further configured to manipulate the azimuthal angle of the audio signal by:
identifying an original azimuthal angle of the audio signal;
calculating an inverse hyperbolic tangent of an input involving the original azimuthal angle; and
multiplying the inverse hyperbolic tangent by at least one constant.

9. The apparatus of claim 1, wherein:
the environment comprises a virtual or augmented environment; and
the sound source comprises a virtual sound source implemented near the user in the virtual or augmented environment.

10. The apparatus of claim 1, further comprising one or more sensors coupled to the eyewear frame and configured to detect at least one of:
sounds produced by one or more additional sound sources in the environment; or
audio information representative an acoustics profile of the environment;
wherein the circuitry is further configured to:
generate an acoustics model of the environment based at least in part on the sounds or the audio information; and
manipulate the azimuthal angle of the audio signal to account for the acoustics model of the environment.

11. The apparatus of claim 10, wherein the additional sound sources comprise at least one of:
a transducer coupled to the eyewear frame; or
an object located in a room occupied by the user.

12. A system comprising:
an eyewear frame dimensioned to be worn by a user;
one or more sensors coupled to the eyewear frame and configured to detect movement of a head of the user; and
circuitry coupled to the eyewear frame and configured to:
obtain an audio signal originating from a sound source in an environment of the user;
manipulate, based at least in part on the movement, an azimuthal angle of the audio signal relative to a location of the sound source in the environment toward a midline feature of the user; and
provide the audio signal for auditory display to the user such that the manipulated azimuthal angle causes the user to perceive the audio signal as originating from the location of the sound source.

13. The system of claim 12, wherein the circuitry is further configured to manipulate the azimuthal angle of the audio signal by at least one of:
compressing the azimuth angle of the audio signal toward the midline feature of the user; or
expanding the azimuth angle of the audio signal away from a lateral feature of the user.

14. The system of claim 13, wherein:
the midline feature comprises a nose of the user or an external occipital protuberance; and
the lateral feature comprises an ear of the user.

15. The system of claim 12, wherein the circuitry is further configured to manipulate the azimuthal angle of the audio signal by applying a transfer function to the audio signal.

16. The system of claim 15, wherein the circuitry is further configured to calibrate the transfer function based at least in part on a preference of the user.

17. The system of claim 12, wherein the circuitry is further configured to manipulate the azimuthal angle of the audio signal by:
identifying an original azimuthal angle of the audio signal;
calculating a product by multiplying a compression constant by a sine function of double the original azimuthal angle; and
subtracting the product from the original azimuthal angle.

18. The system of claim 12, wherein the circuitry is further configured to manipulate the azimuthal angle of the audio signal by:
identifying an original azimuthal angle of the audio signal;
calculating an inverse hyperbolic tangent of an input involving the original azimuthal angle; and
multiplying the inverse hyperbolic tangent by at least one constant.

19. The system of claim 12, wherein:
the environment comprises a virtual or augmented environment; or
the sound source comprises a virtual sound source implemented near the user in the virtual or augmented environment.

20. A method comprising:
obtaining, by circuitry coupled to an eyewear frame, an audio signal originating from a sound source in an environment of a user wearing the eyewear frame;
manipulating, by the circuitry, an azimuthal angle of the audio signal relative to a location of the sound source in the environment toward a midline feature of the user; and
providing, by the circuitry, the audio signal for auditory display to the user such that the manipulated azimuthal angle causes the user to perceive the audio signal as originating from the location of the sound source.
